(19) United States
(12) Patent Application Publication
(10) Pub. No.: US 2008/0163556 A1
(43) Pub. Date: Jul. 10, 2008

(54) AUTOMOTIVE VEHICLE DOOR SYSTEM

(75) Inventor: Martin Witte, Warren, MI (US)

Correspondence Address: BROOKS KUSHMAN P.C./FGTL, 1000 TOWN CENTER, 22ND FLOOR, SOUTHFIELD, MI, 48075-1238, US

(73) Assignee: Ford Global Technologies, LLC, Dearborn, MI (US)

(21) Appl. No.: 11/620,329

(22) Filed: Jan. 5, 2007

(51) Int. Cl. B60J 5/04

(52) U.S. Cl. 49/502

(57) ABSTRACT

A door for an automotive vehicle provides a tailored space to receive a door window if the window is opened.

### BACKGROUND OF THE INVENTION

1. Field of the Invention

The invention relates to automotive vehicle door systems.

2. Discussion

Cabin space within a vehicle may be an important feature for the owner of a vehicle. Cabin space may depend on the distance between the inner door panels of the vehicle.

Some manufacturing processes may require planar interfaces amongst body side, body side inner, floor, and doors to enable fixturing during assembly. Such planar interfaces may includes J-plane and planer A/B line development at the rocker panel.

### SUMMARY

Embodiments of the invention may take the form of a door system for an automotive vehicle. The system includes a window, having a curvature, moveable between parked and dropped positions and an outer panel to provide a show surface for an exterior of the vehicle. The system also includes an inner panel attached with the outer panel. The inner and outer panels form a door shell configured to receive a portion of the window if the window is in the dropped position. The inner panel has a curvature such that the window nests with the inner panel if the window is in the dropped position.

Embodiments of the invention may take the form of a door system for an automotive vehicle. The system includes a window, having a curved shape, moveable between parked and dropped positions and an outer panel to provide a show surface for an exterior of the vehicle. The system also includes an inner panel attached with the outer panel. The inner and outer panels form a door shell configured to receive a portion of the window if the window is in the dropped position. The inner panel has a shape such that the window nests with the inner panel if the window is in the dropped position.

While exemplary embodiments in accordance with the invention are illustrated and disclosed, such disclosure should not be construed to limit the claims. It is anticipated that various modifications and alternative designs may be made without departing from the scope of the invention.

### BRIEF DESCRIPTION OF THE DRAWINGS

FIG. 1 is a perspective view of a door for an automotive vehicle and shows the door in the open position.

FIG. 2 is a perspective view of a portion of the window and shows the curvature of the window.

FIG. 3 is a side elevation view of the driver side and passenger side inner panels and shows the curvature of the inner panels in phantom line.

FIG. 4 is a side elevation view of an alternative embodiment of the driver side and passenger side inner panels and shows the curvature of the inner panels in phantom line.

FIG. 5A is a side view, in cross-section, of the door of FIG. 1 taken along section line 5-5 of FIG. 1 and shows the curvature of the inner panel and the window in the closed position.

FIG. 5B is a top view, in cross-section, of the door of FIG. 1 and shows the curvature of the inner panel.

FIG. 5C is another side view, in cross-section, of the door of FIG. 5A and shows the window in an open position.

FIG. 5D is another side view, in cross-section, of the door of FIG. 5A and shows the window in an open position.

### DETAILED DESCRIPTION

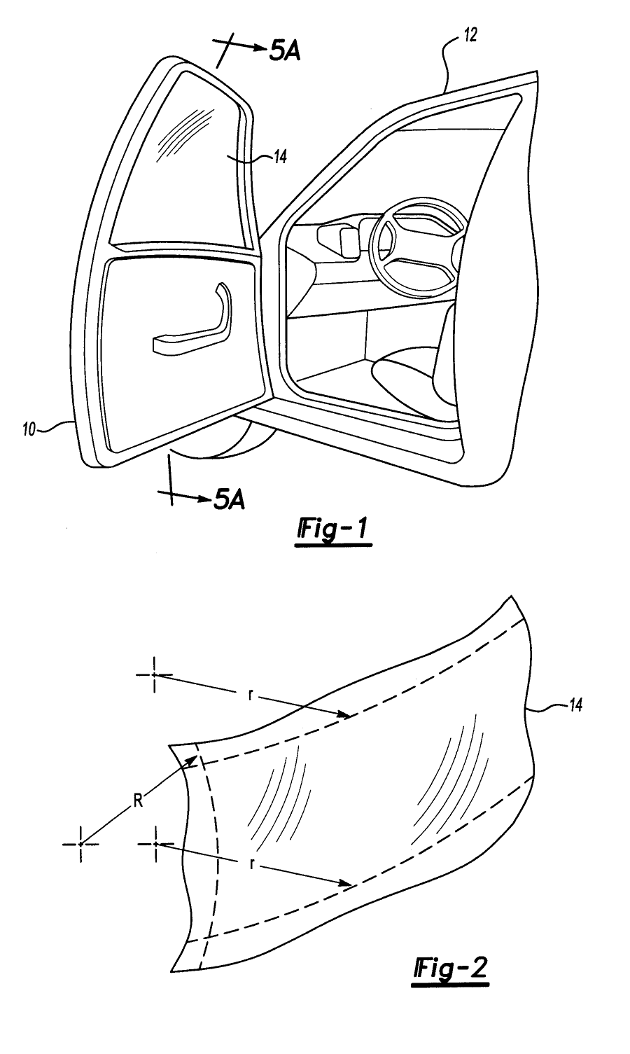

FIG. 1 is a perspective view of a door 10 for an automotive vehicle 12 showing the door in the open position. Door 10 is hingedly attached with vehicle 12. Door 10, however, may be attached with vehicle 12 in any desired fashion. Door 10 includes window 14.

FIG. 2 is a perspective view of a portion of window 14 showing the curvature of window 14. Window 14 is curved in the horizontal and vertical directions. R defines the curvature in the vertical direction and r defines the curvature in the horizontal direction. In other embodiments, window 14 may have curvature only in the horizontal direction or in the vertical direction.

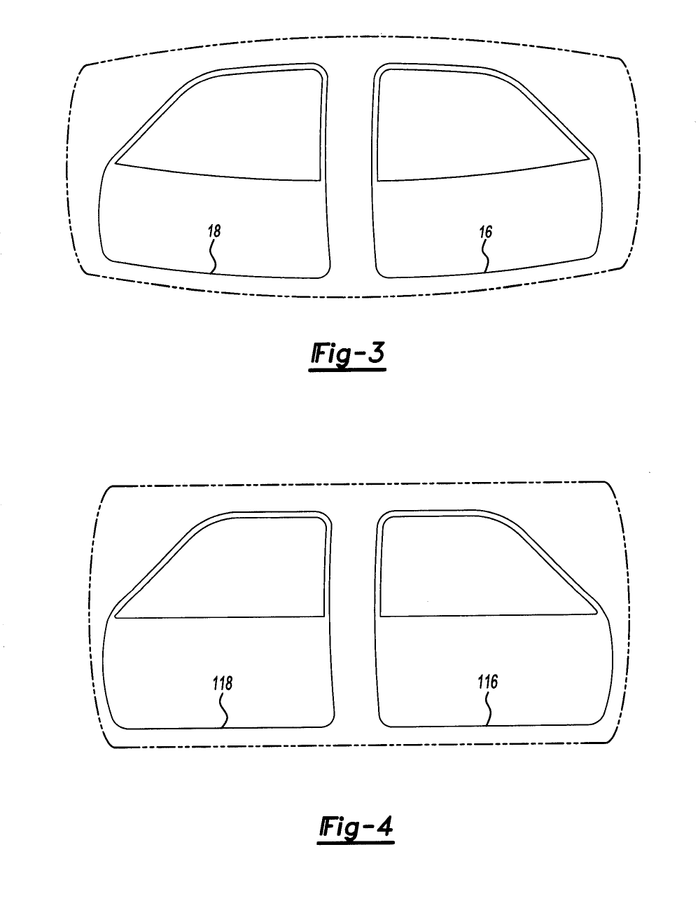

FIG. 3 is a side elevation view of driver side inner panel 16 of door 10 and the corresponding passenger side inner panel 18 of vehicle 12. The phantom line indicates the curvature of inner panels 16, 18.

FIG. 4 is a side elevation view of an alternative embodiment of inner panel 116 of door 110 (not shown) and the corresponding passenger side inner panel 118 of vehicle 112 (not shown). Numbered elements differing by 100 have similar descriptions, e.g., inner panels 16, 116 have similar descriptions. The phantom line indicates the curvature of inner panels 116, 118.

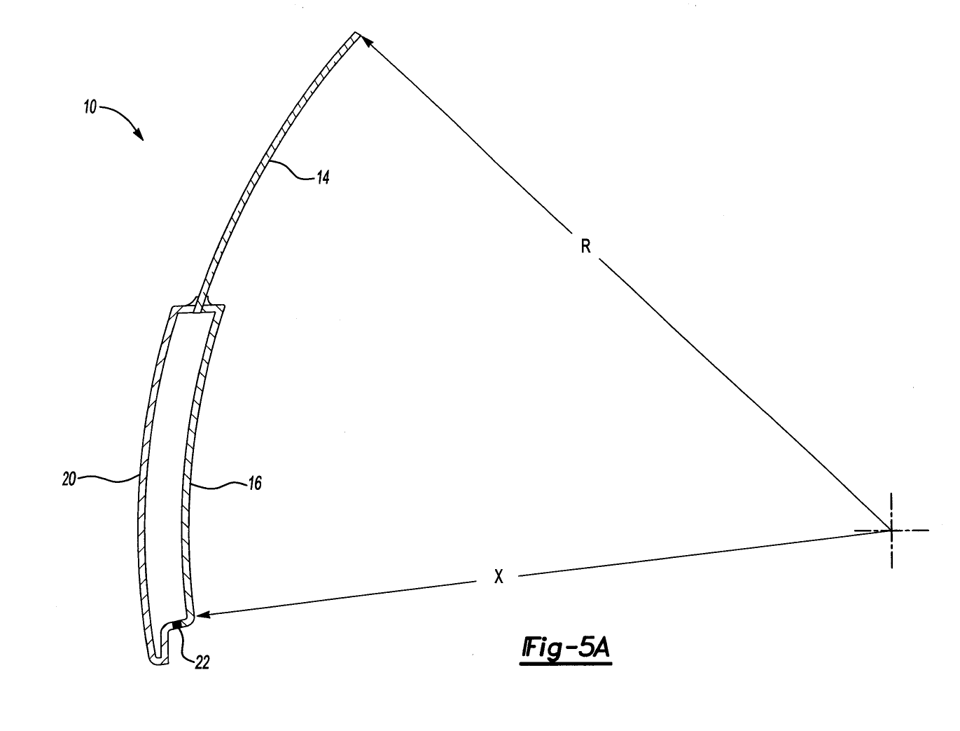

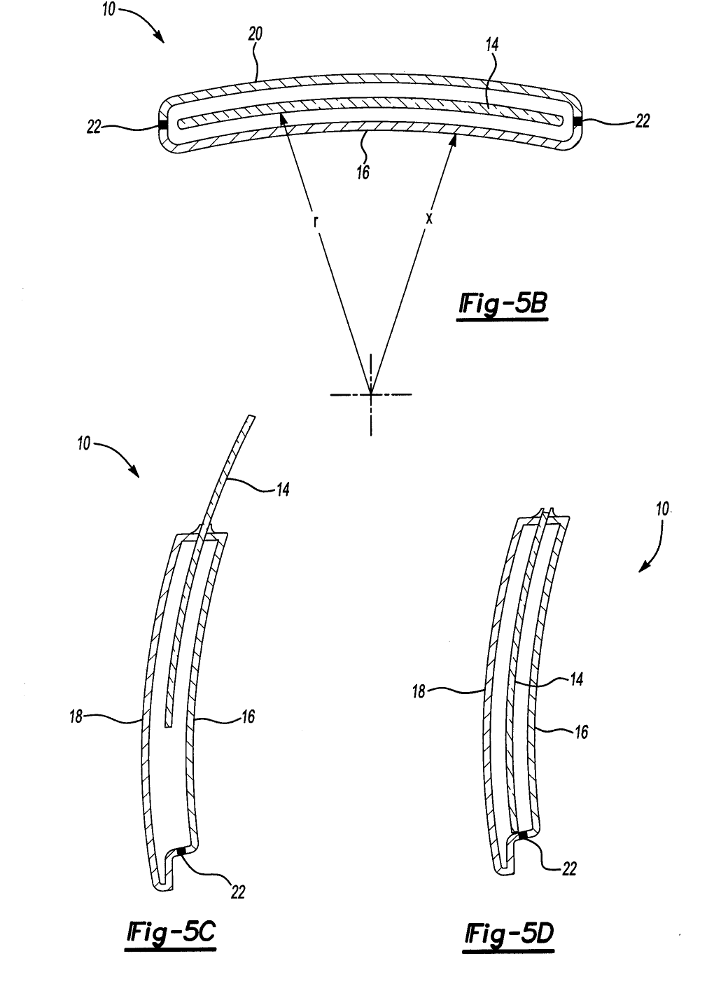

FIG. 5A is a side view, in cross-section, of door 10 of FIG. 1 taken along section line 5-5 of FIG. 1 showing the vertical curvature X of inner panel 16 and window 14 in the closed position. Inner panel 16 and outer panel 20 are attached to form a support structure that can receive window 14 if window is in the open position. Inner panel 16 and outer panel 20 are joined, e.g., welded, at interface 22. In alternative embodiments, inner panel 16 and outer panel 20 may be riveted together or otherwise connected.

Mechanical door systems, e.g., locks, latches, linkages, as well as interior trim components, may be mounted to inner panel 16 in any conventional fashion. Inner panel 16 may also provide sealing surfaces against which door 10 seals with the door opening of vehicle 12 (FIG. 1). Outer panel 20 provides an A-surface for the exterior of vehicle 12. Outer panel 20 also partially defines the shape of vehicle 12.

Inner panel 16 has vertical curvature X. In the embodiment of FIG. 5A, the curvatures of window 14 and inner panel 16 are approximately the same, e.g., R is equal to X. In other embodiments, the curvatures of window 14 and inner panel 16 are not the same, e.g., R does not equal X. In still other embodiments, the curvatures of window 14 and inner panel 16 are not constant. Outer panel 20 has a vertical curvature that may be the same or different from that of window 14.

FIG. 5B is a top view, in cross-section, of the door of FIG. 1 and shows the horizontal curvature x of inner panel 16. In the embodiment of FIG. 5B, the curvatures of window 14 and inner panel 16 are approximately the same, e.g., r is equal to x. In other embodiments, the curvatures of window 14 and inner panel 16 are not the same, e.g., r does not equal x. In still other embodiments, the curvatures of window 14 and inner panel 16 are not constant. Outer panel 20 has a horizontal curvature that may be the same or different from that of window 14.

FIG. 5C is another side view, in cross-section, of door 10 of FIG. 5A showing window 14 in an open position. The curvature of inner panel 16 and outer panel 18 are such that they substantially follow the curvature of window 14 as window 14 moves from the closed position to the open position. Window 14 thus achieves a snug fit between inner panel 16 and outer panel 18.

The curvature of window 14, inner panel 16, and outer panel 20 may vary by design or through manufacturing tolerance. Inner panel 16 and outer panel 20 need not have the same shape as window 14 in order for window 14 to snugly fit between them. Rather, inner panel 16 should loosely conform to the shape of window 14.

FIG. 5D is another side view, in cross-section, of door 10 of FIG. 5A showing window 14 in an open position. In this open position, window 14 achieves a matryoshka-like fit between inner panel 16 and outer panel 20.

The shape of inner panel 16 provides for increased cabin space within vehicle 12. The depth of draw for inner panel 16, if inner panel 16 is a stamping, is also reduced. Such panels may be cost efficient to manufacture.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed:

1. A door system for an automotive vehicle comprising:
a window, having a curvature, moveable between parked and dropped positions;
an outer panel to provide a show surface for an exterior of the vehicle; and
an inner panel attached with the outer panel, the inner and outer panels forming a door shell configured to receive a portion of the window if the window is in the dropped position, the inner panel having a curvature such that the window nests with the inner panel if the window is in the dropped position.

2. The system of claim 1 wherein the window has a barrel curvature.

3. The system of claim 1 wherein the inner panel has a barrel curvature.

4. The system of claim 1 wherein the outer panel has a barrel curvature.

5. The system of claim 1 wherein the window further nests with the outer panel if the window is in the dropped position.

6. The system of claim 1 wherein all of the window is within the door shell if the window is in the dropped position.

7. The system of claim 1 wherein a portion of the window is outside the door shell if the window is in the dropped position.

8. The system of claim 1 wherein the window has a cylindrical curvature.

9. The system of claim 1 wherein the inner panel has a cylindrical curvature.

10. The system of claim 1 wherein the outer panel has a cylindrical curvature.

11. A door system for an automotive vehicle comprising:
a window, having a curved shape, moveable between parked and dropped positions;
an outer panel to provide a show surface for an exterior of the vehicle; and
an inner panel attached with the outer panel, the inner and outer panels forming a door shell configured to receive a portion of the window if the window is in the dropped position, the inner panel having a shape such that the window nests with the inner panel if the window is in the dropped position.

12. The system of claim 11 wherein the window has a barrel shape.

13. The system of claim 11 wherein the inner panel has a barrel shape.

14. The system of claim 11 wherein the outer panel has a barrel shape.

15. The system of claim 11 wherein the window further nests with the outer panel if the window is in the dropped position.

16. The system of claim 11 wherein all of the window is within the door shell if the window is in the dropped position.

17. The system of claim 11 wherein a portion of the window is outside the door shell if the window is in the dropped position.

18. The system of claim 11 wherein the window has a cylindrical shape.

19. The system of claim 11 wherein the inner panel has a cylindrical shape.

20. The system of claim 11 wherein the outer panel has a cylindrical shape.
